(19) United States
(12) Patent Application Publication
(10) Pub. No.: US 2024/0211317 A1
(43) Pub. Date: Jun. 27, 2024

(54) MANAGEMENT SYSTEM AND MANAGEMENT METHOD

(71) Applicant: Mazda Motor Corporation, Hiroshima (JP)

(72) Inventors: Masashi OKAMURA, Aki-gun, Hiroshima (JP); Seiichi ITO, Aki-gun, Hiroshima (JP); Takashi MAEDA, Aki-gun, Hiroshima (JP); Tomohiko ADACHI, Aki-gun, Hiroshima (JP); Masahiro YOSHIOKA, Aki-gun, Hiroshima (JP); Masato ISHIBASHI, Aki-gun, Hiroshima (JP); Daisuke HAMANO, Aki-gun, Hiroshima (JP)

(73) Assignee: Mazda Motor Corporation, Hiroshima (JP)

(21) Appl. No.: 18/288,186

(22) PCT Filed: Apr. 11, 2022
(86) PCT No.: PCT/JP2022/017469

§ 371 Date: Oct. 25, 2023

(30) Foreign Application Priority Data
Apr. 30, 2021 (JP) 2021-077851

(51) Int. Cl. G06F 9/50

(52) U.S. Cl. CPC G06F 9/5072; G06F 2209/5019

(57) ABSTRACT

A management system includes a controller, and a memory unit that stores resource information related to a calculation resource mounted on each moving body and operation history information of each moving body. A controller performs extraction processing of referring to the resource information and the operation history information and extracting a target moving body for reinforcement of a calculation resource, guidance processing of transmitting guidance on the reinforcement of the calculation resource to an owner of the target moving body, and update processing of updating the resource information on the basis of update information when the update information is acquired.

### TECHNICAL FIELD

The technology disclosed herein belongs to a technical field related to a management system and a management method.

### BACKGROUND ART

PTL 1 discloses a system including a plurality of communication devices and a management server that manages grid computing. The management server includes a signal receiver, a state determiner, and a response transmitter. The signal receiver receives a signal indicating that a communication device can participate in grid computing from the communication device. The state determiner determines an insufficient state of a processing capability of each of the plurality of processing devices on the basis of a usage status of a calculation resource of each of the plurality of processing devices. In a case where the processing capability of at least one of the plurality of processing devices is insufficient, the response transmitter transmits a participation instruction to the grid computing to the communication device on the basis of the signal. Such a configuration is intended to allow effective utilization of the calculation resources of the plurality of communication devices.

### CITATION LIST

### Patent Literature

PTL 1: JP 2020-160661 A

### SUMMARY OF THE INVENTION

### Technical Problem

However, in a case where the technology of PTL 1 is applied to a moving body (vehicle or the like) owned by an individual, there is a problem of an action plan of each owner. In a case where the owner uses a moving body, for example, the owner cannot participate in grid computing while the vehicle is traveling. Therefore, even if such a moving body is permitted to be used as a calculation resource of the grid computing, there is a problem that whether the moving body can participate is significantly highly uncertain when requested to participate. That is, in a case where at least one processing capability of the plurality of processing devices is insufficient, even if having received an instruction to participation in the grid computing, the moving body that has received the instruction cannot necessarily participate in the grid computing.

Furthermore, in the case of a moving body owned by an individual, a case where the moving body is not being used by the owner is assumed as a main participation scene in the grid computing. When not being used, the moving body is often placed at each individual's home. Then, it is assumed that moving bodies are physically separated from each other. Considering processing stability of the grid computing, transmission and reception of data between moving bodies, and the like, it is preferable to construct the grid computing between the moving bodies within a certain predetermined distance range. However, when the calculation resource is not sufficient in the moving body existing in the distance range, the calculation capability for executing the grid computing cannot be secured sufficiently in some cases.

The technology disclosed herein has been made in view of such a point, and an object of the technology is to secure an additional calculation resource without arranging an additional vehicle in accordance with an operations status of grid computing processing.

### Solution to Problem

In order to solve the problem described above, the technology disclosed herein is for a management system that manages grid computing utilizing a calculation resource mounted on each of a plurality of moving bodies, the management system including a controller, and a memory unit that store resource information that is information related to the calculation resource mounted on each of the plurality of moving bodies and operation history information indicating a history of calculation processing in the grid computing of each of the plurality of moving bodies, in which the controller performs extraction processing of referring to the resource information and the operation history information stored in the memory unit and extracting a target moving body to be a target for reinforcing the calculation resource from among the plurality of moving bodies, guidance processing of transmitting a guidance on reinforcement of the calculation resource to an owner of the target moving body, and update processing of updating the resource information on the basis of update information indicating that the calculation resource in the target moving body has been reinforced when the update information is acquired.

In the aspect described above, the resource information and the operation history information are referred to, the target moving body of which the calculation resource is to be reinforced is extracted from among the plurality of moving bodies, and a guidance on the reinforcement of the calculation resource is transmitted to urge the reinforcement of the calculation resource. As a result, the calculation resource can be reinforced without changing a framework of the plurality of moving bodies. That is, as in PTL 1, in a case where a processing capability is insufficient, the calculation resource in execution of grid computing processing can be increased without transmitting an instruction to participate in the grid computing to a communication device.

### Advantageous Effect of Invention

As described above, the technology disclosed herein can secure an additional calculation resource without arranging an additional moving body in accordance with an operations status of grid computing processing.

### BRIEF DESCRIPTION OF THE DRAWINGS

FIG. 1 is a schematic diagram exemplifying a configuration of a system according to an embodiment:

FIG. 2 is a conceptual diagram for describing grid computing:

FIG. 3 is a block diagram exemplifying a configuration of a vehicle:

FIG. 4 is a block diagram exemplifying a configuration of a user terminal:

FIG. 5 is a block diagram exemplifying a configuration of a client server;

FIG. 6 is a block diagram exemplifying a configuration of a facility server:

FIG. 7 is a block diagram exemplifying a configuration of a management server;

FIG. 8 is a schematic diagram exemplifying a registration form for a client to request a job from an operation-side server:

FIG. 9 is a schematic diagram illustrating information transmitted between a facility terminal, a vehicle, a client terminal, and a management server:

FIG. 10 is a flowchart exemplifying an operation of a management system:

FIG. 11 is a diagram illustrating an example of an organization of a grid:

FIG. 12 is a diagram illustrating an example of the organization of the grid:

FIG. 13 is a flowchart exemplifying organization processing of the grid:

FIG. 14 is a flowchart exemplifying job acceptance processing:

FIG. 15 is a flowchart exemplifying matching processing; and

FIG. 16 is a flowchart exemplifying grid computing processing.

### DETAILED DESCRIPTION

Hereinafter, an exemplary embodiment will be described in detail with reference to the drawings. Note that the same or corresponding parts in the drawings are denoted by the same reference signs, and are not described repeatedly.

### First Embodiment

### (Grid Computing System)

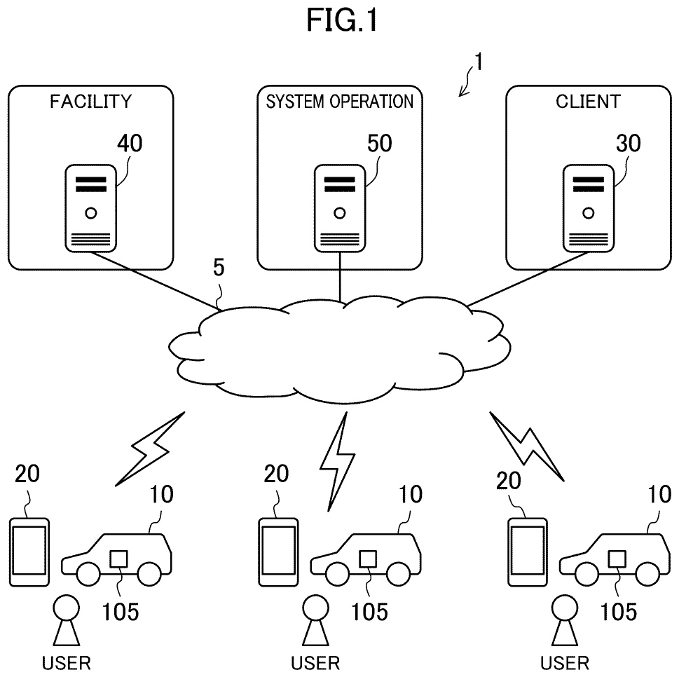

FIG. 1 illustrates a configuration of a grid computing system 1 (hereinafter, also simply referred to as “system 1”) according to an embodiment.

The system 1 includes a plurality of vehicles 10, a plurality of user terminals 20, a client terminal 30, a facility terminal 40, and a management server 50. These components can communicate with each other via a communication network 5. An arithmetic device 105 is mounted on each of the plurality of vehicles 10.

### [Grid Computing]

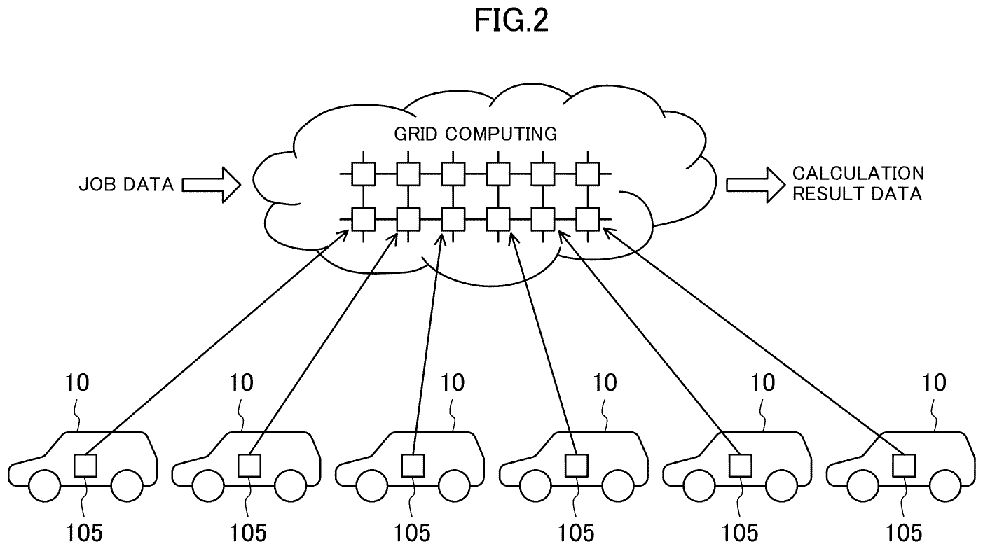

As illustrated in FIG. 2, in the system 1 according to the embodiment, grid computing (hereinafter, also simply referred to as “grid G”) is configured by a plurality of arithmetic devices 105, and grid computing processing of causing an available arithmetic device 105 among the plurality of arithmetic devices 105 to process job data is performed.

When a calculation capability of the arithmetic device 105 is required in the vehicle 10, the arithmetic device 105 enters an operating state, and the calculation capability of the arithmetic device 105 is used. For example, in a case where the vehicle 10 is traveling, the calculation capability of the arithmetic device 105 is required for travel control of the vehicle 10, and the arithmetic device 105 enters the operating state.

On the other hand, when a calculation capability of the arithmetic device 105 is not required in the vehicle 10, the arithmetic device 105 enters a stop state, and the calculation capability of the arithmetic device 105 is not used. For example, when the vehicle 10 is stopped and a power supply of the vehicle 10 is turned off, the calculation capability of the arithmetic device 105 is not required, and the arithmetic device 105 enters the stop state.

### [Vehicle]

The vehicle 10 is owned by a user. The user drives the vehicle 10. In this example, the vehicle 10 is a four-wheeled automobile. A battery (not shown) is mounted on the vehicle 10. The power of the battery is supplied to an in-vehicle device such as the arithmetic device 105. Examples of such a vehicle 10 include an electric vehicle and a plug-in hybrid vehicle.

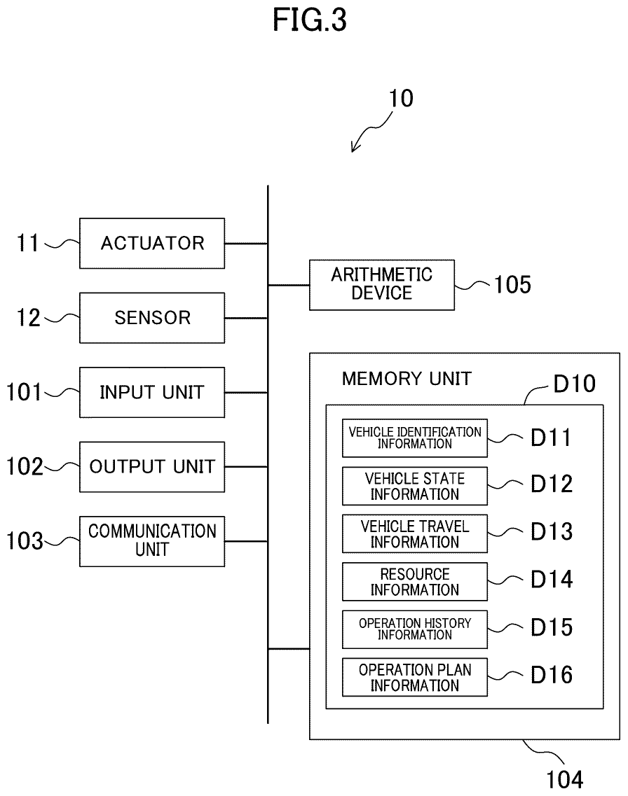

As illustrated in FIG. 3, the vehicle 10 includes an actuator 11, a sensor 12, an input unit 101, an output unit 102, a communication unit 103, a memory unit 104, and the arithmetic device (processor) 105.

The actuator 11 includes an actuator of a drive system, an actuator of a steering system, an actuator of a braking system, and the like. Examples of the actuator of the drive system include an engine, a transmission, and a motor. Examples of the actuator of the braking system include a brake. Examples of the actuator of the steering system include a steering.

The sensor 12 acquires various types of information used for controlling the vehicle 10. Examples of the sensor 12 include a vehicle exterior camera that images the outside of the vehicle, a vehicle interior camera that images the inside of the vehicle, a radar that detects an object outside the vehicle, a vehicle speed sensor, an acceleration sensor, a yaw rate sensor, an accelerator opening sensor, a steering sensor, and a brake hydraulic sensor.

The input unit 101 inputs information and data. Examples of the input unit 101 include an operation unit that inputs information according to an operation by being operated, a camera that inputs an image indicating information, and a microphone that inputs sound indicating information. The information and data input to the input unit 101 are sent to the arithmetic device 105.

The output unit 102 outputs information and data. Examples of the output unit 102 include a display unit that outputs an image indicating information and a speaker that outputs sound indicating information.

The communication unit 103 transmits and receives information and data. The information and data received by the communication unit 103 are transmitted to the arithmetic device 105.

The memory unit 104 memorizes information and data. A specific configuration of the memory unit 104 is not limited. For example, the memory unit 104 may be implemented by a memory built in a chip, by a hard disk drive (HDD) or a solid state drive (SSD), or by an optical disk such as a DVD or a BD. In the present disclosure, a memory area mounted on the vehicle 10 and capable of storing and accumulating data is collectively referred to as a storage 108. In other words, the memory unit 104 is implemented by a part of the memory area of the storage 108.

In this example, the memory unit 104 memorizes vehicle information D10. The vehicle information D10 includes vehicle identification information D11, vehicle state information D12, vehicle travel information D13, resource information D14, operation history information D15, and operation plan information D16.

### <Vehicle Identification Information>

The vehicle identification information D11 is information for identifying each vehicle 10. Specifically, the vehicle identification information D11 includes vehicle identification information for identifying the vehicle 10, user identification information for identifying the user who owns the vehicle 10, and grade information (including performance of the drive system of the vehicle and optional conditions) of the vehicle 10 indicating a performance of the vehicle 10.

### <Vehicle State Information>

The vehicle state information D12 is information indicating a state of the vehicle 10. For example, the vehicle state information D12 includes vehicle position information, vehicle communication information, vehicle power supply information, vehicle battery remaining level information, vehicle charge information, and the like. The vehicle position information indicates a position (latitude and longitude) of the vehicle 10. For example, the vehicle position information can be acquired by a global positioning system (GPS). The vehicle communication information indicates a communication state of the vehicle 10. The vehicle power supply information indicates a state of the power supply of the vehicle 10. For example, the vehicle power supply information indicates on/off of an ignition power supply, on/off of an accessory power supply, and the like. The vehicle battery remaining level information indicates a remaining level of the battery (not shown) mounted on the vehicle 10. The vehicle charge information indicates whether the vehicle 10 is being charged in a charging facility (not shown).

### <Vehicle Travel Information>

The vehicle travel information D13 is information indicating a travel history of the vehicle 10. For example, the vehicle travel information D13 indicates the position and time of the vehicle 10 in association with each other. Note that, in addition to travel history information, travel plan information indicating a future travel plan of the vehicle 10 may be included.

### <Resource Information>

The resource information D14 is information related to a calculation resource 109 (described later) (a CPU 106, a GPU 107, and the storage 108 described later).

As for the arithmetic device 105 (including the CPU 106 and GPU 107), for example, the resource information D14 includes an arithmetic device ID set for the arithmetic device 105, the vehicle ID set for the vehicle 10 on which the arithmetic device 105 is mounted, and arithmetic device performance information indicating performance of the arithmetic device 105. The arithmetic device ID may be set for each of the CPU 106 and the GPU 107, for example. The arithmetic device performance information includes, for example, performance information of each of the CPU 106 and the GPU 107.

The resource information D14 includes, for example, information related to the storage 108 that can be allocated to the grid computing processing, for example, information such as a memory capacity value, a storage type (HDD, SSD, flash memory, or the like), a write speed and read speed to each storage 108, and an error rate. Furthermore, the resource information related to the storage 108 may include a memory capacity value equipped in the entire vehicle and a current free capacity value.

The arithmetic device ID is an example of arithmetic device identification information for identifying the arithmetic device 105. The performance of the arithmetic device 105 indicated in the arithmetic device performance information includes a calculation capability indicating the calculation capability (specifically, a maximum calculation capability) of the arithmetic device 105, a ratio of the CPU 106 and the GPU 107 in the arithmetic device 105, and the like. Note that the calculation capability of the arithmetic device 105 is a data volume that the arithmetic device 105 can process per unit time.

### <Operation History Information>

The operation history information D15 is information indicating an operation history of the arithmetic device 105. For example, the operation history information D15 indicates a use rate of the calculation capability of the arithmetic device 105 and/or a processing volume of a job and the time in association with each other. The operation history information D15 includes a normal operation history and a grid operation history. The normal operation history is, for example, information indicating a history of operation of the arithmetic device 105 for use by the user, such as traveling of the vehicle and provision of services such as car navigation and music reproduction. The grid operation history is information indicating a history of operation of the arithmetic device 105 to execute the grid computing processing.

### <Operation Plan Information>

The operation plan information D16 is information indicating an operation plan of the arithmetic device 105. Specifically, the operation plan information D16 indicates use history information indicating a past use status of the arithmetic device 105, use plan information indicating a future use status of the arithmetic device 105, and the like.

The arithmetic device 105 controls each unit of the vehicle 10. In this example, the arithmetic device 105 controls the actuator 11 in accordance with various types of information obtained by the sensor 12.

The arithmetic device 105 includes a processor, a memory, and the like. Examples of the processor include a central processing unit (CPU) and a graphics processing unit (GPU). The memory memorizes a program for operating the processor, information and data indicating a processing result of the processor, and the like.

Note that the number of the processors mounted on the arithmetic device 105 may be one or more. Furthermore, the processor mounted on the arithmetic device 105 may be only one of the CPU 106 or the GPU 107, or may be both the CPU 106 and the GPU 107. In this example, the arithmetic device 105 includes both the CPU 106 and the GPU 107. For example, the arithmetic device 105 includes one or a plurality of electronic control units (ECUs).

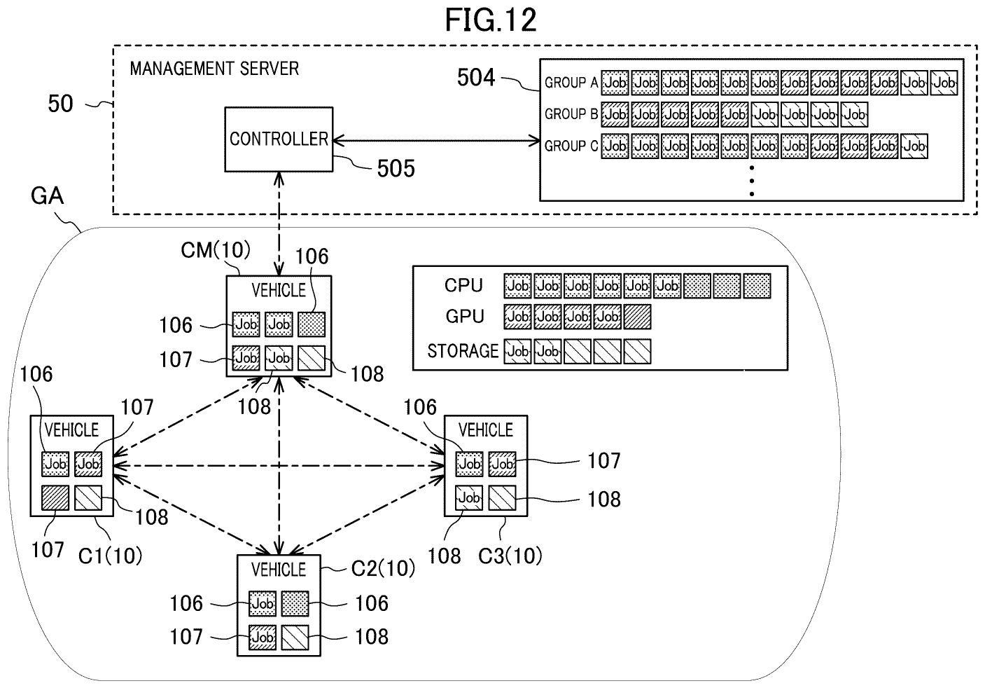

The arithmetic device 105 includes at least one of the CPU 106 or the GPU 107. In the present disclosure, a resource available for calculation and processing of the grid computing is referred to as “calculation resource 109”. The calculation resource 109 includes a part or all of the CPU 106, the GPU 107, and the storage 108 mounted on the vehicle 10. For example, in FIG. 12 described later, three CPUs 106, one GPU 107, and one storage 108 are mounted on a master vehicle CM as calculation resources. Similarly, one CPU 106, two GPUs 107, and one storage 108 are mounted on a vehicle C1, two CPUs 106, one GPU 107, and one storage 108 are mounted on a vehicle C2, and one CPU 106, one GPU 107, and two storages 108 are mounted on a vehicle C3. Note that a part of the CPU 106, the GPU 107, and the storage 108 mounted on the vehicle 10 may be used as the calculation resource 109. That is, for example, the CPU 106, the GPU 107, and the memory unit 104 may include a part that cannot be used as the calculation resource 109 or is limited in use.

In addition, for example, a time zone in which the use as the calculation resource 109 is permitted and a time zone in which the use as the calculation resource 109 is restricted may be divided. That is, a single CPU 106 may be counted as the calculation resource 109 in a certain time zone, and may not counted as the calculation resource 109 in other time zones. The same applies to the GPU 107 and the storage 108.

In addition, in a case where the CPU 106 is implemented by a single core or a plurality of cores, a part of the plurality of cores may be counted as the calculation resource 109, and the other cores may not be counted as the calculation resource 109. The same applies to the GPU 107. Similarly, a part of the memory area of the storage 108 may be counted as the calculation resource 109, and the other parts of the memory area may not be counted as the calculation resource 109.

### [User Terminal]

The user terminal 20 is owned by the user. The user operates the user terminal 20 to use various functions. Furthermore, the user can carry the user terminal 20. Examples of such a user terminal 20 include a smartphone, a tablet, and a laptop personal computer.

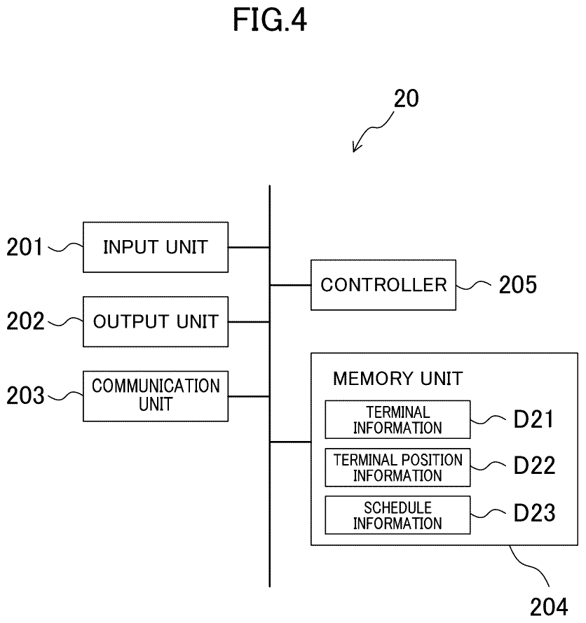

As illustrated in FIG. 4, the user terminal 20 includes an input unit 201, an output unit 202, a communication unit 203, a memory unit 204, and a controller 205.

The input unit 201 inputs information and data. Examples of the input unit 201 include an operation unit that inputs information according to an operation by being operated, a camera that inputs an image indicating information, and a microphone that inputs sound indicating information. The information input to the input unit 101 is sent to the arithmetic device 105.

The output unit 202 outputs information and data. Examples of the output unit 202 include a display unit that outputs an image indicating information and a speaker that outputs sound indicating information.

The communication unit 203 transmits and receives information and data. The information and data received by the communication unit 303 are transmitted to the controller 205.

The controller 205 controls each unit of the user terminal 20. The controller 205 includes a processor, a memory, and the like. The memory memorizes a program for operating the processor, information and data indicating a processing result of the processor, and the like.

The memory unit 204 memorizes information and data. In this example, the memory unit 204 stores terminal information D21, terminal state information D22, and schedule information D23.

### <Terminal Information>

The terminal information D21 is information related to the user terminal 20. For example, the terminal information D21 includes a user terminal ID set for the user terminal 20, user terminal performance information indicating performance of the user terminal 20, and the like. The user terminal ID is an example of user terminal identification information for identifying the user terminal 20.

### <Terminal State Information>

The terminal state information D22 is information indicating a state of the user terminal 20. The terminal state information D22 includes user terminal position information indicating a position of the user terminal 20, the user terminal communication state information indicating a communication state of the user terminal 20, and the like.

### <Schedule Information>

The schedule information D23 indicates an action history and an action plan of the user who owns the user terminal 20. For example, the schedule information D23 indicates a position of the user and a stay period (or a planned stay period) in association with each other. Note that the schedule information D23 can be acquired by a schedule function mounted on the user terminal 20. Specifically, when the user inputs his/her action history and action plan to the user terminal 20 by using the schedule function, the schedule information D23 indicating the action history and action plan of the user is obtained.

### [Client Server]

The client terminal 30 is owned by a client. The client requests calculation of the job data. Examples of such a client include enterprises, research institutions, and educational institutions.

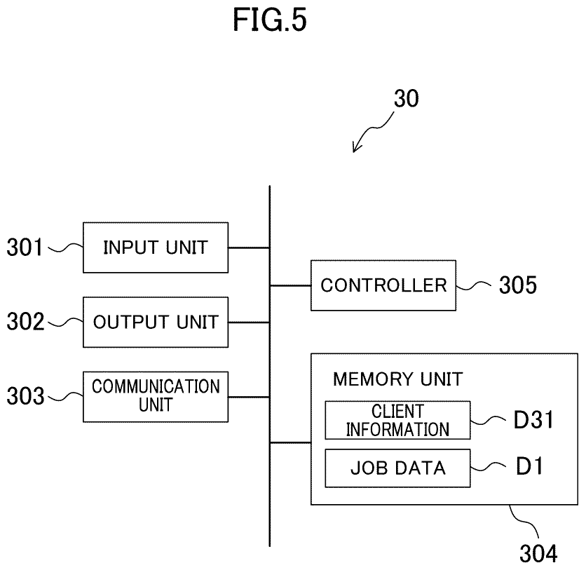

As illustrated in FIG. 5, the client terminal 30 includes an input unit 301, an output unit 302, a communication unit 303, a memory unit 304, and a controller 305.

The input unit 301 inputs information and data. Examples of the input unit 301 include an operation unit that inputs information according to an operation by being operated, a camera that inputs an image indicating information, and a microphone that inputs sound indicating information. The information and data input to the input unit 301 are sent to the controller 305.

The output unit 302 outputs information and data. Examples of the output unit 302 include a display unit that outputs an image indicating information and a speaker that outputs sound indicating information.

The communication unit 303 transmits and receives information and data. The information and data received by the communication unit 303 are transmitted to the controller 305.

The controller 305 controls each unit of the client terminal 30. The controller 305 includes a processor, a memory, and the like. The memory memorizes a program for operating the processor, information and data indicating a processing result of the processor, and the like.

The memory unit 304 memorizes information and data. In this example, the memory unit 304 memorizes client information D31 and job data D1.

### <Client Information>

The client information D31 is information related to the client. The client information D31 includes a client ID set for the client, a client terminal ID set for the client terminal 30 owned by the client, the name of a person in charge, an address, a telephone number, and the like. The client ID is an example of client identification information for identifying the client. The client server ID is an example of client identification information for identifying the client terminal 30.

### <Job Data>

The job data D1 is data corresponding to a job and is data processed for execution of the job.

Note that the job data D1 can be classified by calculation types. Examples of the calculation types include a calculation type of a CPU system and a calculation type of a GPU system. The job data D1 of the calculation type of the CPU system tends to require complicated calculation with many conditional branches, such as simulation calculation. The job data D1 of the calculation type of the GPU system tends to require an enormous amount of simple calculation such as image processing and machine learning.

The job data D1 can be classified by processing conditions. Examples of the processing conditions include a processing condition requiring constant communication, and a processing condition requiring no constant communication. In the job data D1 of the processing condition requiring constant communication, it is required that the arithmetic device 105 is always communicable in the grid computing processing. In the job data D1 of the processing condition requiring no constant communication, it is not required that the arithmetic device 105 is always communicable in the grid computing processing.

### <Job Information>

Note that the memory unit 304 may memorize job information related to a job. The job information includes job name information indicating the name of the job, job content information describing the content of the job, job data information related to job data corresponding to the job, job delivery date information indicating a delivery date of the job, and the like. The job data information indicates a calculation type, a processing condition, a necessary calculation capability, and the like of the job data.

### [Facility Terminal]

The facility terminal 40 is owned by a facility. The user visits the facility. The user can make a visit reservation to the facility. Examples of such a facility include a shop, a stadium, a theater, a supermarket, a restaurant, and an accommodation facility.

In this example, the facility is a dealer or a maintenance factory configured to be able to perform maintenance of the vehicle, and the facility terminal 40 is a terminal provided in the dealer or the maintenance factory. Instead of the facility terminal 40, a facility server provided in a facility may be used. In this case, a block configuration and the like may be similar to those of the facility terminal 40.

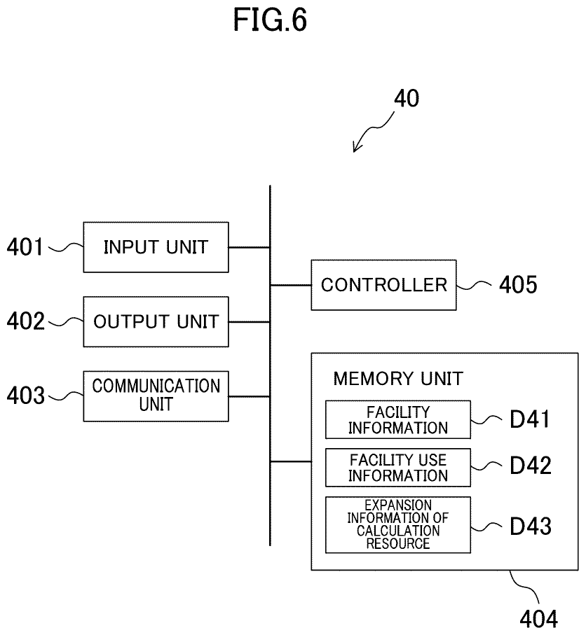

As illustrated in FIG. 6, the facility terminal 40 includes an input unit 401, an output unit 402, a communication unit 403, a memory unit 404, and a controller 405. The configurations of the input unit 401, the output unit 402, the communication unit 403, the memory unit 404, and the controller 405 of the facility terminal 40 are similar to the configurations of the input unit 301, the output unit 302, the communication unit 303, the memory unit 304, and the controller 305 of the client terminal 30.

In this example, the memory unit 404 memorizes facility information D41, facility use information D42, and expansion information D43 of the calculation resource.

### <Facility Information>

The facility information D41 is information related to the facility. The facility information D41 includes a facility ID set for the facility, a facility terminal ID set for the facility terminal 40 owned by the facility, facility position information indicating a position (latitude and longitude) of the facility, the name of a person in charge, an address, a telephone number, and the like. The facility terminal ID is an example of facility identification information for identifying the facility terminal 40.

### <Facility Use Information>

The facility use information D42 includes use history information of a facility such as a shop or a maintenance factory, maintenance information, and use reservation information of the facility. The maintenance information includes information such as maintenance schedule information of each vehicle, a type of maintenance, a maintenance content to be performed, inquiry information about maintenance, and information to be transmitted at the time of maintenance. In addition, the facility use information D42 includes a reservation date and time of a user's visit and a purpose of the visit to the facility including expansion or replacement of the calculation resource. Furthermore, when the purpose of the visit includes “expansion or replacement of the calculation resource”, the expansion information D43 of the calculation resource 109 described later is associated with the facility use information of the user. Note that as the facility use information D42, information that associates the user who visits the facility and a stay period (or a planned stay period) with each other may be included.

### <Expansion Information of Calculation Resource>

The expansion information D43 of the calculation resource 109 is information associating the vehicle identification information D11 of the vehicle subjected to expansion and information of the calculation resource 109 subjected to expansion or replacement.

The form of expansion of the calculation resource 109 is not limited. For example, the form of expansion may be an all-in-one micro-processing unit (MPU) board on which the CPU 106, the GPU 107, and the storage 108 are mounted, or may be a single board specialized for the calculation resource (one or more of the CPU 106, the GPU 107, or the storage 108) to be expanded.

The information of the calculation resource 109 to be expanded or replaced is, for example, a name and identification code of the board as described above, and is registered in an obvious form for the user of the facility terminal 40 and an operator who expands the board (calculation resource).

### [Management Server]

The management server 50 manages an operation of the grid computing. In other words, the management system that manages the grid computing utilizing the calculation resources 109 mounted on each of the plurality of vehicles 10 includes the management server 50. The management server 50 is owned by a company that operates the system 1.

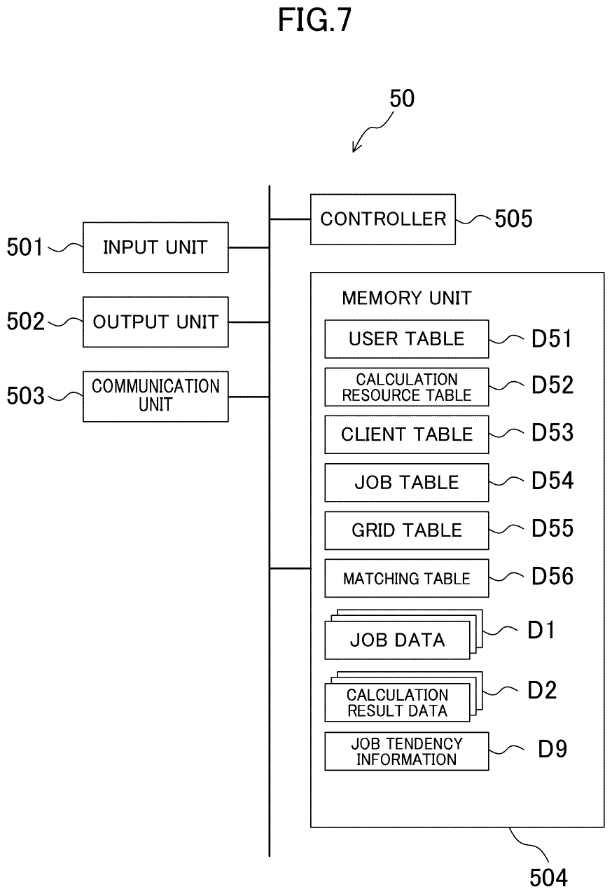

As illustrated in FIG. 7, the management server 50 includes an input unit 501, an output unit 502, a communication unit 503, a memory unit 504, and a controller 505. The configurations of the input unit 501, the output unit 502, and the communication unit 503 of the management server 50 are similar to the configurations of the input unit 301, the output unit 302, and the communication unit 303 of the client terminal 30. The memory unit 504 and the controller 505 are examples of components of a management system that manages the grid computing.

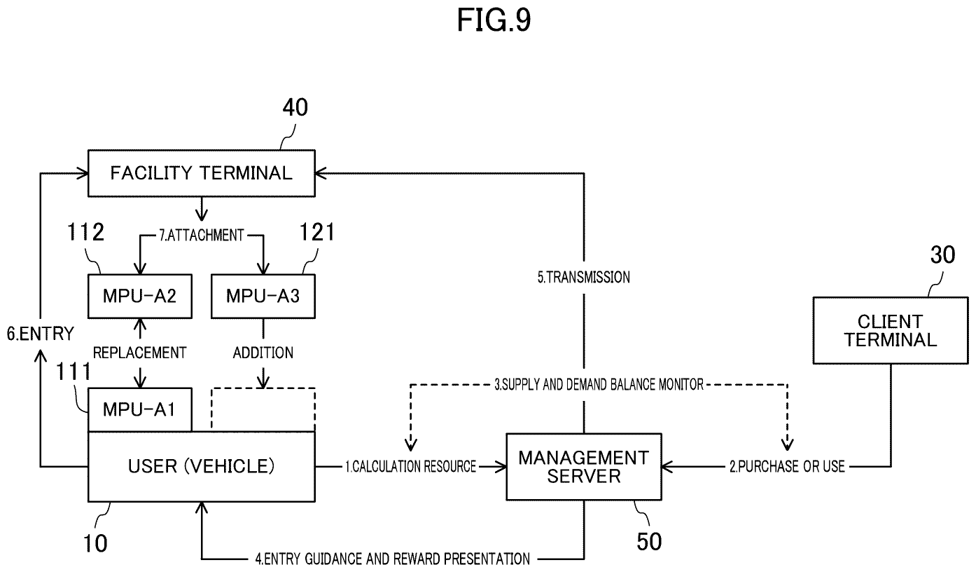

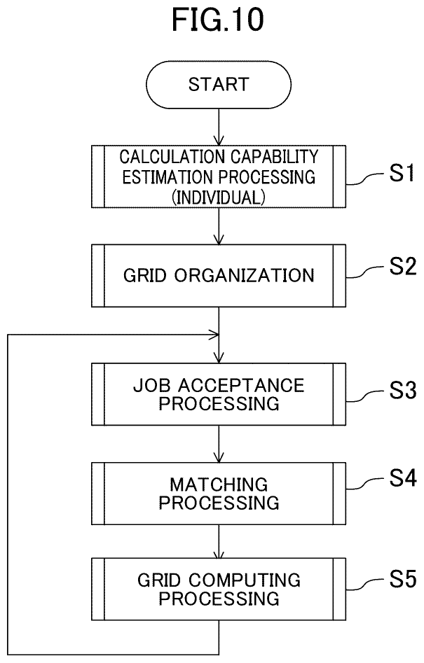

In this example, the controller 505 has a function of executing a series of control and processing related to the operation and management of the grid computing. Specifically, control and processing for implementing the flow indicated by the arrow illustrated in FIG. 9, and control and processing in the flowchart of FIG. 10 and subsequent drawings are executed. Note that, in the following description, for convenience of description, the management server 50 is mainly described, but there is a case where some processing and control are implemented by the controller 505 contributing to the processing and control. For example, the controller 505 is configured to mainly execute “extraction processing”, “guidance processing”, “update processing”, “calculation capability estimation processing”, “job estimation processing”, and “determination processing” described later. Each processing will be specifically described later with reference to the drawings such as a flowchart.

The controller 505 includes a processor, a memory, and the like. Examples of the processor include a central processing unit (CPU) and a graphics processing unit (GPU). The memory memorizes a program for operating the processor, information and data indicating a processing result of the processor, and the like. Note that the number of processors for implementing the controller 505 may be one or more.

The memory unit 504 memorizes information and data. A specific configuration of the memory unit 504 is not limited. For example, the memory unit 104 may be implemented by a memory built in a chip, by a hard disk drive (HDD) or a solid state drive (SSD), or by an optical disk such as a DVD or a BD.

In this example, the memory unit 504 stores various data such as a user table D51, a calculation resource table D52, a client table D53, a job table D54, a grid table D55, a matching table D56, job data D1, calculation result data D2, and job tendency information D9.

### <User Table>

The user table D51 is a table for managing users. In the user table D51, for each user, a user ID set for the user, a vehicle ID (for example, VIN) set for the vehicle 10 owned by the user (hereinafter, also referred to as owned vehicle), a calculation resource ID set for the calculation resource 109 owned by the user, a user terminal ID set for the user terminal 20 owned by the user, and the like are registered. Furthermore, in the user table D51, in relation to the user, the use history information of the dealer or the maintenance factory, maintenance information D4 including maintenance date information D3 such as the next maintenance date or a periodic maintenance date of the owned vehicle, the grade information of the owned vehicle, the information as to whether to expand the calculation resource of the owned vehicle, and the like may be registered.

### <Calculation Resource Table>

The calculation resource table D52 is a table for managing the calculation resource 109. In the calculation resource table D52, for each calculation resource 109, a calculation resource ID set for the calculation resource 109, a user ID set for a user who owns the calculation resource 109, a vehicle ID set for the vehicle 10 on which the calculation resource 109 is mounted, and the like are registered.

In the calculation resource table D52, a type of the calculation resource 109, a specification (calculation capability, storage capacity, and the like) of the calculation resource 109, an operation status (operation history and operation plan) of the calculation resource 109, and the like are registered for each calculation resource 109. In other words, the calculation resource table D52 includes operation status information D5 indicating the operation status of each of a plurality of calculation resources 109 and calculation resource information D6 indicating a performance of each of the plurality of calculation resources 109.

When the calculation resource 109 is the CPU 106 or the GPU 107, the calculation resource information D6 includes calculation capability information D7 indicating the calculation capability of each of the calculation resources 109. The calculation capability here includes a temporal change in the calculation capability. In other words, the calculation capability information D7 includes the meaning of the calculation capability that can be exhibited in a predetermined period in consideration of the temporal change in the calculation capability.

In addition, in a case where the calculation resource 109 is the storage 108, storage performance information D8 indicating performance of the storage 108 such as the memory capacity, the writing and reading speed of data, and the error rate is included. Storage performance here includes a temporal change in the storage performance. In other words, the storage performance information D8 includes the meaning of the storage performance that can be exhibited in a predetermined period in consideration of the temporal change in the performance.

### <Client Table>

The client table D53 is a table for managing clients. In the client table D53, for each client, a client ID set for the client, a client terminal ID set for the client terminal 30 owned by the client, the name of a person in charge, an address, a telephone number, and the like of the client are registered.

### <Job Table>

The job table D54 is a table for managing a job requested by the client. In the job table D54, for each job, an acceptance number set for the job, a client ID set for the client who has requested the job, a name and content of the job, and the like are registered. In the job table D54, for each job, a calculation type and a processing condition of job data corresponding to the job, a necessary calculation capability which is a calculation capability required for the calculation of the job data, a delivery date set for the job, and the like are registered.

### <Grid Table>

The grid table D55 is a table for managing a calculation capability of the grid G and each of the grids G in the grid computing processing.

In the grid table D55, for each grid G, a grid ID for identifying the grid G, vehicle identification information D11 of the vehicle configuring the grid G, a calculation capability by the calculation resource 109 configuring the grid G, and the like are registered. The calculation capability here includes a prediction result of a temporal change in the calculation capability in addition to basic performance (calculation specification) as a premise of calculation.

In other words, in the grid table D55, executable job information D59 that is a provisional predicted value of a job that is predicted to be processable in the grid G when considered in a predetermined period in the grid computing processing is registered.

In the grid table D55, other vehicle information D10 (for example, the resource information D14) may be registered in association with the vehicle identification information D11.

### <Matching Table>

The matching table D56 is a table for managing a result of matching processing described later. In the matching table D56, for each job, an acceptance number set for the job, a job data ID set for the job data D1 corresponding to the job, a grid ID of the grid G allocated to the job data by the matching processing, and the like are registered.

### <Job Data>

The job data D1 memorized in the memory unit 504 is the job data D1 accepted by job acceptance processing described later.

### <Calculation Result Data>

The calculation result data D2 memorized in the memory unit 504 is data of a calculation result of the job executed by the grid computing processing described later, and indicates a result of the calculation.

### [Operation of Grid Computing System]

FIG. 9 is a schematic diagram illustrating information transmitted between the facility terminal, the vehicle, the client terminal, and the management server. FIG. 10 is a flowchart illustrating an example of the operation of the management system.

### <Step S1>

In step S1, the management server 50 estimates the calculation capability of each vehicle 10.

First, the management server 50 requests each vehicle 10 to transmit the latest vehicle information D10. Each vehicle 10 that has received the transmission request of the vehicle information D10 from the management server 50 transmits participant information to the management server 50). As the vehicle information D10 transmitted at this time, a part of the vehicle information D10 may be transmitted, or all the vehicle information D10 may be transmitted. The transmitted vehicle information D10 includes the vehicle identification information D11 and the resource information D14. The management server 50 registers the vehicle information D10 received from each vehicle 10 in the calculation resource table D52. For the vehicle 10 in which the vehicle information D10 is already registered in the management server 50, necessary information among difference information from registered registration information may be transmitted from the vehicle 10 to the management server 50.

Next, the management server 50 executes the calculation capability estimation processing of referring to the vehicle information D10 registered in the calculation resource table D52 and estimating the calculation resource information D6, for example. The calculation resource information D6 includes the calculation capability information D7 and the storage performance information D8 of each vehicle.

In the calculation capability estimation processing, the information referred to by the management server 50 is, for example, a vehicle state of each vehicle 10, a calculation amount of the calculation resource 109, a calculation type that can be covered by the calculation resource 109, or calculable time. As for the calculatable time, for example, a specific schedule may be received from the vehicle 10, or a past use tendency of the vehicle 10 and the arithmetic device 105 of the vehicle 10 saved in the memory unit 504 may be analyzed, and a schedule in a time zone in which the arithmetic device 105 can be used as the calculation resource may be predicted. Note that in a case where information corresponding to the calculation resource information D6 is received from each vehicle 10, it is sufficient to use the information.

The management server 50 registers the acquired or predicted calculation resource information D6 in the calculation resource table D52.

The management server 50 registers the estimated calculation resource information D6 in the calculation resource table D52 in association with the vehicle identification information D11 of each vehicle 10.

### <Step S2>

In step S2, the management server 50 executes grid organization processing of organizing the grid G for executing the grid computing processing.

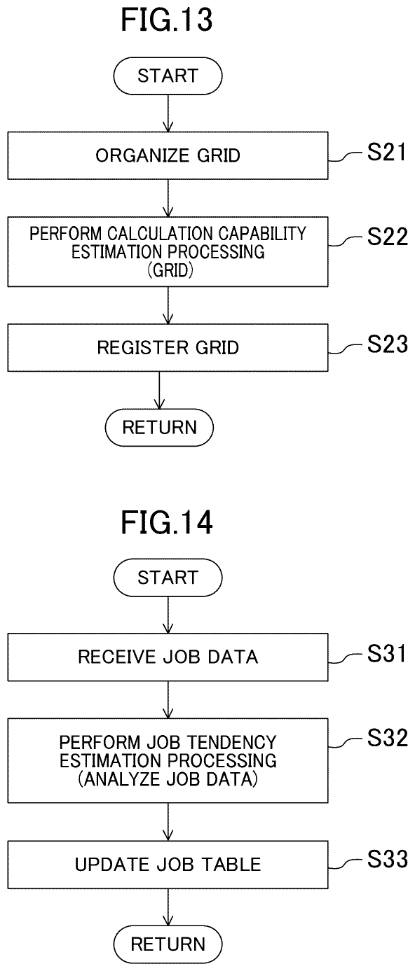

Hereinafter, the grid organization processing will be described with reference to FIG. 13.

### —Step S21—

First, the management server 50 configures each grid G. The grid G is configured on the basis of the calculation resources 109 available for grid computing processing (also simply referred to as the “calculation resource 109”) among the arithmetic device 105 and the storage 108 mounted on each vehicle 10.

A method of configuring the grid G is not limited, but for example, the grid G may be configured by vehicles having a high possibility of stopping in a predetermined area at a specific time. In this case, for example, the grid G may be configured on the basis of the position of the user's home, or in a case where the user commutes by car, the grid G may be configured at a workplace, an office, or the like. In addition, for example, the grid G may be configured by vehicles having a complementary relationship in the calculation resource 109.

Furthermore, for example, the management server 50 may configure the grid G in accordance with a requested job, a job having a high tendency to be requested, a difficulty level of a job to be handled, or the like, for example, may configure the grid G so that a job specialized for use of the GPU 107 can be executed.

In addition, the management server 50 may take a method of configuring the grid G in which a plurality of grid candidates are created in advance and the grid G is finally determined in accordance with the job. In that case, the grid G is organized or reorganized between step S3 and step S5 (see FIG. 10).

In addition, the management server 50 may cancel the grid G once and form a new grid G again after completion of the grid computing processing described later. In other words, the grid G may be reconstructed in loop processing of steps S3 to S5 (see FIG. 10) described later. Note that, in the following description, for convenience of description, it is assumed that the grid G organized in step S2 is maintained, and the processing of step S3 and subsequent steps is advanced.

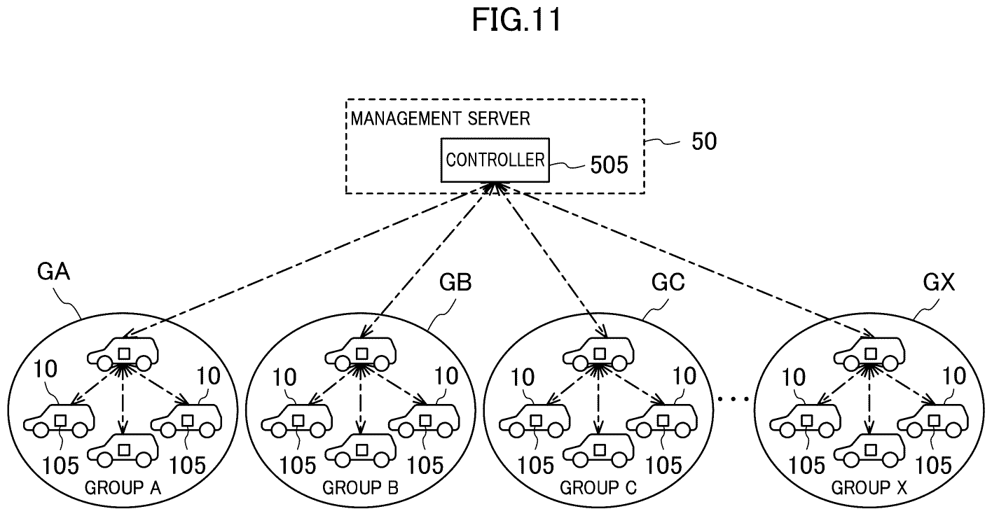

FIG. 11 illustrates an example in which grids GA, GB, GC, . . . , and GX are configured by grouping for each of a plurality of vehicles.

Note that the management server 50 may configure the grid G in accordance with a tendency, a type, or the like of a job requested from the client terminal 30 described later. In addition, the number or combination of the vehicles 10 configuring the grid G may be appropriately changed in accordance with the requested job.

As illustrated in FIG. 12, the management server 50 may determine the master vehicle CM that manages a job allocated to the grid G from among the vehicles 10 configuring the grid G. Then, the management server 50 may basically exchange data with the master vehicle CM. In this case, the master vehicle CM has a management function of managing other vehicles 10 (for example, the vehicles C1 to C3 in FIG. 12) belonging to the same grid and a function as a relay device between the other vehicles (for example, the vehicles C1 to C3 in FIG. 12) and the management server 50. A method of selecting the master vehicle CM is not limited, but is selected on the basis of, for example, a participation rate in the grid computing processing, the performance of the mounted calculation resource 109, and the like.

### —Step S22—

Next, the management server 50 executes estimation processing of the calculation capability and the storage performance of each grid G.

Specifically, the management server 50 refers to the calculation resource table D52 of each vehicle 10 configuring the grid G, and estimates the calculation capability and the storage performance of the grid G on the basis of the calculation resource information D6 of each vehicle 10.

### —Step S23—

When the grid G is organized in step S21, the management server 50 associates a grid ID for identifying the grid G with the vehicle information D10 of each vehicle 10 and registers the grid ID and the vehicle information D in the grid table D55. At that time, the management server 50 registers the calculation capability and the storage performance of the grid G estimated in step S22 in association with each other.

### <Step S3>

In step S3, the management server 50 executes the job acceptance processing. Hereinafter, the job acceptance processing will be described with reference to FIG. 14.

In the job acceptance processing, the management server 50 performs the following processing every time job data D1 (job request) is received from the client terminal 30.

### —Step S31—

First, the management server 50 accepts a job request from a client. Specifically, the client terminal 30 transmits a job request application to the management server 50 in response to an operation by a person in charge of the client. The management server 50 performs the following processing in response to the application.

The management server 50 requests the client terminal 30 to transmit information necessary for acceptance of the job (specifically, the client information D31 related to the client who requests the job and job information related to the job). In this example, the management server 50 transmits image data of a job acceptance screen to the client terminal 30. The client terminal 30 reproduces an image of the job acceptance screen from the image data, and causes the output unit 302 (display unit) to output (display) the image.

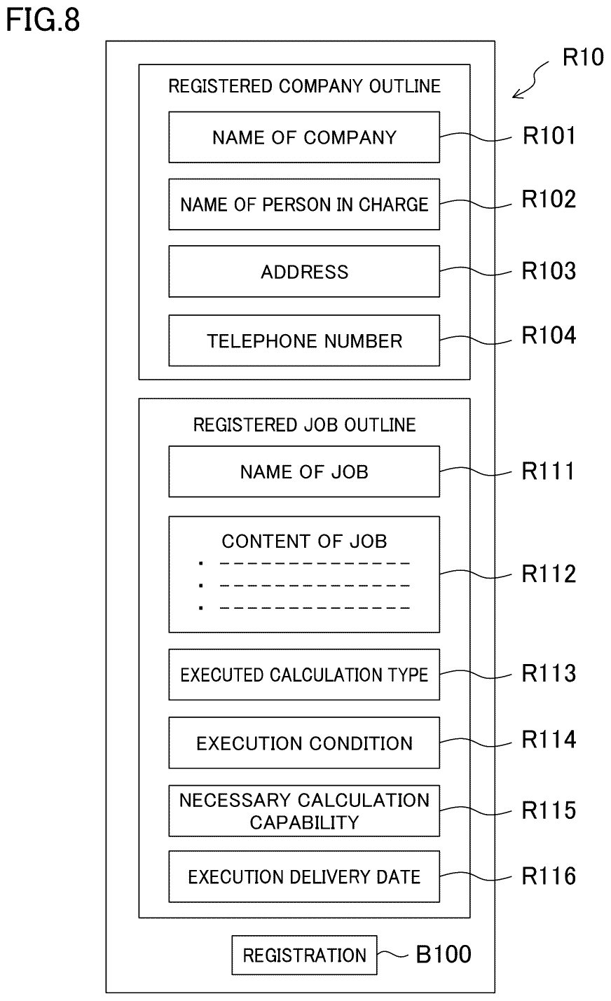

FIG. 8 is an example of a registration form R10 for the client to request a job from the management server 50. The registration form R10 is displayed in a format that can be input to a display unit of a computer owned by the client, for example. The input information of the registration form R10 includes information necessary when the management server 50 matches a grid G including a plurality of vehicles (also simply referred to as “grid G”) with a job.

The registration form R10, for example, as an outline of a company (corresponding to a client), has an input field R101 of a company name, an input field R102 of a person in charge, an input field R103 of an address of the company, and an input field R104 of a telephone number. The registration form R10 includes, for example, as a job outline, a job name input field R111, a job content input field R112, a job calculation type input field R113, a job execution condition input field R114, a job required calculation capability input field R115, a calculation result delivery date R116, and the like. As the content of the job, for example, the purpose of the job, the importance of the job in the client, and the like are input. As the calculation type of the job, for example, information of the CPU system, the GPU system, or the like is input, similarly to the “calculation type” in the calculation capability information described above. As the job execution condition, for example, the presence or absence of constant communication with the client terminal 30, recommended communication capability, and the like are input. As the required calculation capability of the job, for example, similarly to the “calculation capability” in the calculation capability information described above, the calculation capability required to execute the job is input in units of FLOPS. As the delivery date of the calculation result, the date and time are input. Note that information other than the above information may be input to the registration form R10. For example, the registration form R10 may include an item for inputting a data format of a calculation result desired by the client. In addition, an item for attaching a program necessary for executing the job may be provided in the registration form R10.

The person in charge of the client operates the input unit 301 (operation unit) of the client terminal 30 to input necessary information for the job acceptance screen. As a result, the client information related to the client who requests the job and the job information related to the job are input. When the input of the above information is completed, the person in charge of the client operates the input unit 301 (operation unit) of the client terminal 30, and presses the registration button B100 on the job acceptance screen. When the registration button B100 is pressed, the client terminal 30 transmits the information (client information and job information) input on the job acceptance screen to the management server 50. The management server 50 receives the client information and the job information.

Next, the management server 50 requests the client terminal 30 to transmit the job data D1 corresponding to the requested job. In response to the request, the client terminal 30 transmits the job data D1 corresponding to the requested job to the management server 50. The management server 50 receives the job data D1.

### —Step S32—

Next, the management server 50 analyzes the job data D1 received in step S31. Specifically, the management server 50 analyzes a calculation type, a processing condition, necessary calculation capability, and the like of the job data D1. The management server 50 estimates the tendency of the job requested from the client terminal on the basis of the analysis result such as the calculation type, the processing condition, and the necessary calculation capability of the job data D1. The estimated tendency of the job is memorized in the memory unit 504 as the job tendency information D9.

Note that, the management server 50 may correct the job information received in step S31 as necessary on the basis of the analysis result of the job data D1.

### —Step S33—

Next, the management server 50 associates the client information received in step S31 with the job information, registers the client information and the job information in the job table D54, and updates the job table D54. Furthermore, in the management server 50, the job data D1 received in step S31 is memorized in the memory unit 504 in a form that can be referred to on the basis of the corresponding client information or job information. When the update of the job table D54 and the memorization of the job data D1 are completed, the job acceptance processing is completed.

Note that the job data D1 only needs to be obtained before the grid computing processing, and thus, for example, the job data D1 may be received after the end of the matching processing described later. Then, it is possible to avoid unnecessary transmission and reception of data in a case where matching is not satisfactory.

### <Step S4>

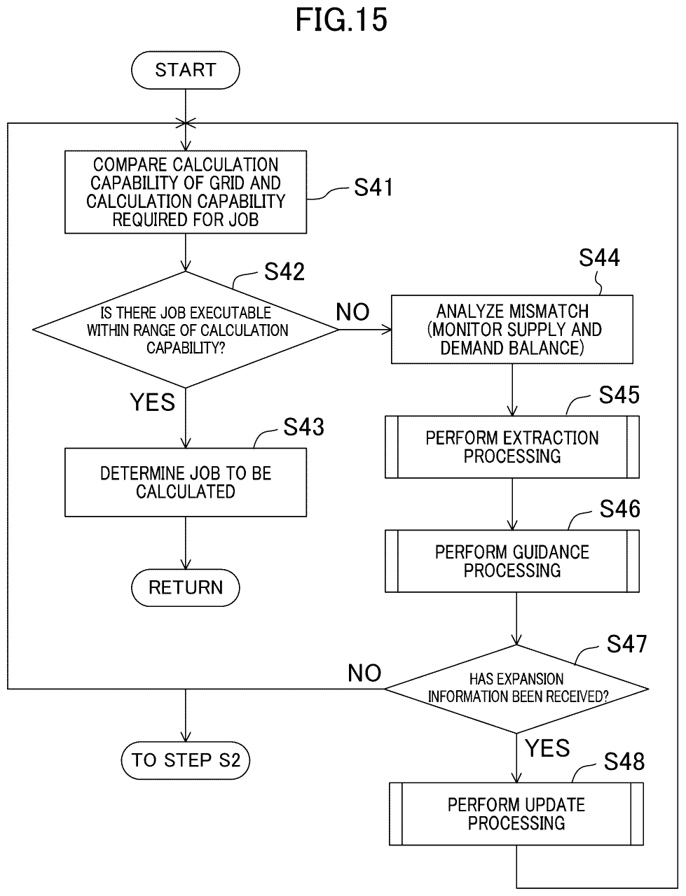

In step S4, the management server 50 executes the matching processing. Hereinafter, the matching processing will be described with reference to FIG. 15.

### —Step S41—

First, the management server 50 compares the estimated calculation capability with the calculation capability required for the accepted job. The management server 50 not only compares a simple processing capability, but also compares a time zone in which the job can be provided with the delivery date of the job, and compares the communication state of a place in which the job can be provided with necessity of constant communication in the job.

### —Step S42—

Next, the management server 50 determines whether there is a job that is executable with the estimated calculation capability among the currently registered jobs. When there is an executable job (YES in S42), the flow proceeds to step S43. On the other hand, when there is no job that is executable with the estimated calculation capability (NO in S42), the flow proceeds to step S44.

### —Step S43—

The management server 50 determines a job to be actually calculated by the grid G from among the executable jobs. In a case where there is one job, the job is assigned to a target grid G. On the other hand, in a case where there is a plurality of executable jobs, a job to be assigned to the target grid G is determined on the basis of a predetermined priority order. A method of prioritizing here can be arbitrarily set, and is not limited. For example, it is possible to set the priority order on the basis of the delivery date or an execution schedule, by, for example, elevating the priority order of a closer delivery date. Furthermore, for example, the priority order can be set on the basis of the particularity of the job and the difficulty level of the job, such as whether execution is possible in other grids G.

### —Step S44—

In step S42, the management server 50 analyzes a cause of absence of a job that is executable with the estimated calculation capability of the target grid G. Specifically, the management server 50 refers to the job tendency information D9 in the memory unit 504, and extracts an insufficient calculation resource from among the calculation resources 109 of the target grid G from the tendency of the job requested from the client terminal 30.

In other words, the management server 50 monitors a supply and demand balance between the job requested from the client (demand) and the calculation capability of the target grid G (supply). Then, a future demand trend is predicted on the basis of the monitoring result, and on the basis of the prediction result, the calculation resource 109 that is insufficient in the target grid G or the calculation resource 109 that is insufficient or tends to be insufficient in organizing the grid G in step S2 are extracted. After the extraction of the calculation resource 109, the flow proceeds to step 45.

Note that, in the extraction processing of a target vehicle in step S45 described later, step S44 may be omitted in a case where information of the calculation resource 109 that is insufficient or tends to be insufficient is not used. In that case, after the NO determination in step S42, the processing proceeds to step S45.

### —Step S45—

The management server 50 refers to the resource information D14 and the operation history information D15 stored in the memory unit 504, and executes the extraction processing of extracting a target vehicle 10 to be a target for reinforcing the calculation resource 109 (hereinafter, also simply referred to as a target vehicle 10) from among the vehicles 10 configuring the target grid G.

A method of extracting the target vehicle 10 is not limited, but for example, the calculation resource to be reinforced is specified on the basis of the tendency of the job registered in the job tendency information D9 and an estimated value of the calculation capability of the target grid G, and a vehicle in which the calculation resource can be reinforced is extracted as the target vehicle 10. As a result, since the calculation resource 109 can be reinforced in accordance with the tendency of the requested job, an effect of further increasing a matching rate of the job can be obtained.

In addition, for example, the vehicle 10 in which the calculation resource 109 determined to be insufficient in step S44 can be reinforced may be set as the target vehicle 10. As a result, it is possible to reinforce the calculation resource 109 that is actually insufficient, that is, reinforce the calculation resource 109 corresponding to the latest actual demand.

In addition, for example, the management server 50) may refer to the maintenance date information D3 on the user table D51 and set the vehicle 10 whose maintenance date is closer among the target grids G to be higher in priority in the extraction processing described above. By making it possible to set the expansion in accordance with the maintenance date, the user can perform expansion in accordance with a planned maintenance. Accordingly, the expansion by the user can be promoted.

In addition, for example, in a case where the master vehicle CM is designated, the master vehicle CM or the vehicle 10 planned to be the master vehicle may be set as the target vehicle 10. As described above, the master vehicle CM, which is a host vehicle, also executes the grid computing processing, and also performs a function of managing other vehicles 10 belonging to the same target grid G and a function as a relay device between other vehicles 10 and the management server 50. Therefore, by reinforcing the calculation resource 109 of the master vehicle CM, it is possible to contribute to improvement of performance and stability as the grid G without merely improving the performance as a terminal that performs the grid computing processing.

After the extraction processing in step S45, the flow proceeds to step S46.

### —Step S46—

The management server 50 executes the guidance processing of transmitting guidance on reinforcement of the calculation resource 109 to the owner of the target vehicle 10.

Specifically, the management server 50 presents, to the user terminal 20, an expansion guidance of the calculation resource 109 and a reward due to the expansion of the calculation resource 109.

The expansion guidance of the calculation resource 109 includes, for example, reservation guidance information (for transmission of a reservation form and the like) or entry guidance information (entry date and time, facility name, facility address, and the like) of a dealer or a maintenance factory, and the like.

The management server 50 may guides the owner of the target vehicle 10 through an additional function or additional service made available at a time of use of the vehicle 10 by reinforcement of the calculation resource 109 in accordance with the expansion guidance of the calculation resource 109.

For example, reinforcing the arithmetic device 105 (the CPU 106, the GPU 107, and/or the storage 108) directly leads to performance improvement of the vehicle in a case where the grid computing processing is not executed, that is, in a daily driving scene. Therefore, by making it possible to guide the owner of the target vehicle through an additional function or additional service by reinforcing the calculation resource, it is possible to motivate the user to perform expansion.

### —Step S47—

In step S47, it is determined whether the expansion information is received from the facility terminal 40 to the management server 50. Hereinafter, a flow until the expansion information is received from the facility terminal 40 to the management server 50 will be described.

After the guidance processing of step S46, the fact that the user wishes expansion is transmitted from the user terminal 20 to the management server 50. Then, the management server 50 transmits entry reservation information of the target vehicle 10 and the expansion information D43 which is the information of the calculation resource 109 (for example, the MPU board) expanded in the target vehicle 10 to the facility terminal 40.

Upon receiving the expansion information D43, the facility terminal 40 registers the information in the memory unit 404. Then, when the user actually visits the facility, the staff of the facility performs expansion work on the basis of the entry reservation information and the expansion information D43. For example, as illustrated in FIG. 9, in the facility, an old MPU-A1 is replaced by a new MPU-A2, or a new MPU-A3 is added to an empty slot or the like.

When the expansion work of the calculation resource 109 is completed, the information is registered in the facility terminal 40 and transmitted to the management server 50.

When the expansion information is received in the management server 50, YES determination is obtained in step S47, and the flow proceeds to the next step S48.

On the other hand, when the user is in a state before entry or when the expansion is refused, NO determination is obtained in step S47. Then, for example, the processing returns to step S41 to match the grid G with a new job, or returns to step S2 to form the grid G again.

### [Grid Computing Processing]

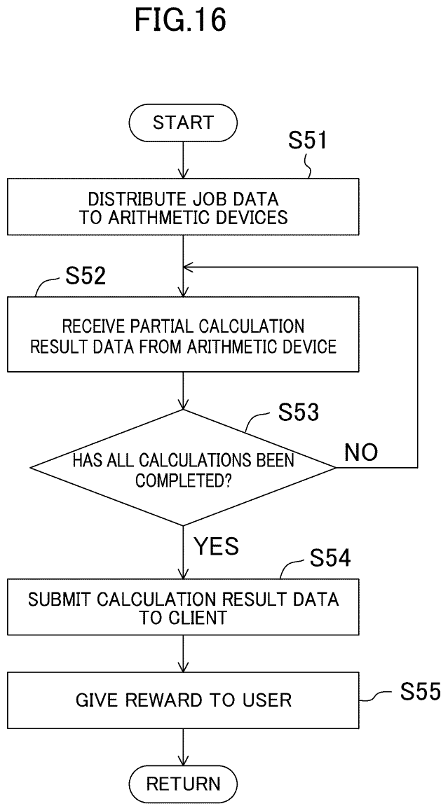

Next, the grid computing processing of step S5 will be described with reference to FIG. 16. In the grid computing processing, the available arithmetic device 105 among the plurality of arithmetic devices 105 is caused to process the job data D1. The management server 50 performs the following processing after completion of the matching processing of step S4.

### <Step S51>

First, the management server 50 refers to the matching table D56 and distributes the job data D1 to be subjected to the grid computing processing to the calculation resources 109 allocated to the job data D1 in the matching processing. Specifically, the management server 50 transmits a part of the job data D1 to each of the calculation resources 109 allocated to the job data D1. As a result, the job data D1 is processed in parallel by the calculation resources 109 (CPU 106 and GPU 107) allocated to the job data D1.

### <Step S52>

Next, when the calculation of the data (a part of the job data D1) transmitted to the calculation resource 109 is completed, each of the calculation resources 109 (CPU 106 and GPU 107) transmits partial calculation result data obtained by the calculation to the management server 50. The management server 50 receives the partial calculation result data transmitted from the calculation resource 109, and memorizes the partial calculation result data in the memory unit 504.

### <Step S53>

The management server 50 determines whether all the arithmetic devices 105 to which the job data D1 has been distributed in step S51 have completed the calculation. In a case where all the arithmetic devices 105 have completed the calculation, the processing of step S54 is performed, and otherwise, the processing of step S52 is performed.

### <Step S54>

When all the arithmetic devices 105 have completed the calculation, the management server 50 combines the partial calculation result data memorized in the memory unit 504 to generate calculation result data D2 (calculation result data D2 indicating a result of the calculation of the job data D1) corresponding to the job data D1 to be subjected to the grid computing processing. Then, the management server 50 transmits the calculation result data D2 corresponding to the job data D1 to be subjected to the grid computing processing to the client terminal 30 of the client who has requested the calculation of the job data D1.

### <Step S55>

Next, a reward is given from the company operating the system 1 to the user who has provided the calculation capability of the arithmetic device 105 to the grid computing processing. Examples of the reward given to the user include points available in the system 1, virtual currency, and a product discount benefit. For example, the management server 50 performs processing for giving a reward to the user who has provided the calculation capability of the arithmetic device 105 to the grid computing processing. Examples of the processing for giving a reward include processing of registering a “user ID” set for the user and a “point” (or virtual currency) available in the system 1 in association with each other in the user table D51, and processing of transmitting information indicating a discount benefit of a product to the user terminal 20 owned by the user.

Alternatively, a reward may be given from the client to the user who has provided the calculation capability of the arithmetic device 105 to the grid computing processing. For example, the client terminal 30 may execute processing for giving a reward to the user who has provided the calculation capability of the arithmetic device 105 to the grid computing processing.

### Effects of Embodiment

As described above, in the present embodiment, the resource information D14 and the operation history information D15 are referred to, the target vehicle 10 of which the calculation resource 109 is to be reinforced is extracted from among the plurality of vehicles 10, and a guidance on the reinforcement of the calculation resource 109 is transmitted to urge the reinforcement of the calculation resource 109. As a result, the calculation resource 109 of the grid G can be reinforced without changing a framework of the grid G. That is, as in PTL 1, in a case where the processing capability of a plurality of communication devices corresponding to the grid G is insufficient, the calculation resources 109 of the grid G can be increased without transmitting an instruction to participate in the grid computing to other communication devices (vehicles in the present embodiment).

### Other Embodiments

In the above description, a case where the memory unit 504 and the controller 505 of the management system are aggregated into a single management server 50 has been described as an example, but this case is not restrictive. For example, the memory unit 504 and the controller 505 may be distributed to a plurality of management servers 50 (not shown) that communicate with each other via the communication network 5.

In addition, in the above description, the memory unit 504 of the management system may be configured by a single memory device or may be configured by a plurality of memory devices. The plurality of memory devices may be aggregated into a single management server 50 or may be distributed to a plurality of management servers 50 (not shown) that communicate with each other via the communication network 5.

Furthermore, in the above description, the controller 505 of the management system may be configured by a single control unit or may be configured by a plurality of control units. The plurality of control units may be aggregated into a single management server 50 or may be distributed to a plurality of management servers 50 (not shown) that communicate with each other via the communication network 5.

Furthermore, in the above description, the arithmetic device 105 may be configured by a single arithmetic unit or may be configured by a plurality of arithmetic units. The plurality of arithmetic units may be aggregated into a single management server 50 or may be distributed to a plurality of management servers 50 (not shown) that communicate with each other via the communication network 5.

In the above description, a case where the arithmetic device 105 is mounted on the vehicle 10 (specifically, a four-wheeled vehicle) has been described as an example, but this case is not restrictive. For example, the arithmetic device 105 may be mounted on another moving body other than the vehicle 10. Examples of such a moving body include a transport machine and a mobile information terminal. Examples of the transport machine include a motorcycle, a railway vehicle, a ship, an aircraft, and a drone. The vehicle is an example of a transport machine. Examples of the mobile information terminal include a laptop personal computer, a tablet, and a smartphone.

In addition, the above embodiments may be appropriately combined and implemented. The above embodiments are inherently preferable examples, and are not intended to limit the scope of the technology disclosed herein, the application of the technology, or the use of the technology. That is, the above embodiments are merely examples, and the scope of the present disclosure should not be interpreted in a limited manner. The scope of the present disclosure is defined by the claims, and all modifications and changes falling within the equivalent scope of the claims are within the scope of the present disclosure.

### INDUSTRIAL APPLICABILITY

As described above, the technology disclosed herein is useful as a technology for managing the grid computing.

### REFERENCE SIGNS LIST

10 vehicle (moving body)
50 management server (management device)
504 memory unit
505 controller
D3 maintenance date information
D14 resource information
D15 operation history information

1. A management system that manages grid computing utilizing a calculation resource mounted on each of a plurality of moving bodies, the management system comprising:
a controller; and
a non-transitory memory that has stored therein resource information that is information related to the calculation resource mounted on each of the plurality of moving bodies and operation history information indicating a history of calculation processing in the grid computing of each of the plurality of moving bodies, wherein
the controller is configured to perform
extraction processing of referring to the resource information and the operation history information stored in the memory unit and extracting a target moving body to be a target for reinforcing the calculation resource from among the plurality of moving bodies,
guidance processing of transmitting a guidance on reinforcement of the calculation resource to an owner of the target moving body, and
update processing of updating the resource information on a basis of update information indicating that the calculation resource in the target moving body has been reinforced when the update information is acquired.

2. The management system according to claim 1, wherein, the controller is further configured to perform
calculation capability estimation processing of referring to the resource information and the operation history information and estimating a calculation capability of a grid in a case where the grid is configured by the plurality of moving bodies, and
job estimation processing of estimating a tendency of a job requested from a client terminal, and
in the extraction processing, the controller specifies the calculation resource to be reinforced on a basis of the tendency of the job and an estimated value of the calculation capability of the grid, and extracting a moving body in which the calculation resource to be reinforced is reinforceable as the target moving body.

3. The management system according to claim 1, wherein
the controller is further configured to perform determination processing of referring to moving body information that is information related to the moving bodies, the resource information, and the operation history information and determining a main moving body that manages the job of the grid computing, the job being allocated from among the plurality of moving bodies, and
the controller extracts the main moving body as the target moving body in the extraction processing.

4. The management system according to claim 1, wherein
the non-transitory memory stores information of a maintenance date of each of the plurality of moving bodies, and
the controller sets a moving object of which the maintenance date is closer to be higher in priority in the extraction processing.

5. The management system according to claim 1, wherein the controller, in the guidance processing, guides the owner of the target moving body through an additional function made available at a time of use of the moving body by reinforcement of the calculation resource.

6. A management method of managing, by using a management device, grid computing utilizing a calculation resource mounted on each of a plurality of moving bodies, the management method comprising
by using resource information that is information related to the calculation resource mounted on each of the plurality of moving bodies and operation history information indicating a history of calculation processing in the grid computing of each of the plurality of moving bodies,
performing
extraction processing of referring to the resource information and the operation history information stored in a memory unit of the management device and extracting a target moving body to be a target for reinforcing the calculation resource from among the plurality of moving bodies,
guidance processing of transmitting a guidance on reinforcement of the calculation resource to an owner of the target moving body, and
update processing of updating the resource information on a basis of update information indicating that the calculation resource in the target moving body has been reinforced when the update information is acquired.

7. The management system according to claim 2, wherein
the non-transitory memory stores information of a maintenance date of each of the plurality of moving bodies, and
the controller sets a moving object of which the maintenance date is closer to be higher in priority in the extraction processing.

8. The management system according to claim 7, wherein the controller, in the guidance processing, guides the owner of the target moving body through an additional function made available at a time of use of the moving body by reinforcement of the calculation resource.

9. The management system according to claim 3, wherein
the non-transitory memory stores information of a maintenance date of each of the plurality of moving bodies, and
the controller sets a moving object of which the maintenance date is closer to be higher in priority in the extraction processing.

10. The management system according to claim 9, wherein the controller, in the guidance processing, guides the owner of the target moving body through an additional function made available at a time of use of the moving body by reinforcement of the calculation resource.

11. The management system according to claim 3, wherein the controller, in the guidance processing, guides the owner of the target moving body through an additional function made available at a time of use of the moving body by reinforcement of the calculation resource.

12. The management system according to claim 4, wherein the controller, in the guidance processing, guides the owner of the target moving body through an additional function made available at a time of use of the moving body by reinforcement of the calculation resource.
